(19) United States
(12) Patent Application Publication
(10) Pub. No.: US 2009/0295112 A1
(43) Pub. Date: Dec. 3, 2009

(54) STEERING, SUSPENSION AND FIXATION SYSTEM FOR MOTORCYCLE WHEELS

(76) Inventors: Nuno Manuel Filipe Maroco, Guarda (PT); Antonio Maria Sanches Ruivo, Alcains (PT)

Correspondence Address: SUGHRUE MION, PLLC, 2100 PENNSYLVANIA AVENUE, N.W., SUITE 800, WASHINGTON, DC, 20037, US

(21) Appl. No.: 11/997,366

(22) PCT Filed: Aug. 1, 2005
(86) PCT No.: PCT/PT05/00008

§ 371 Date: Oct. 6, 2008

(51) Int. Cl. B62K 21/00

(52) U.S. Cl. 280/124.11

(57) ABSTRACT

The present invention reports to steering, suspension and fixation system of motorcycle wheels with damping in extension at the front wheel and compression at the rear wheel. The steering system comprises a steering axle (1) connected to the support fork (5) of the motorcycle front wheel (6), by a mechanism comprising a steering arm (2), a crank (3) and arm (4) of the support fork (5) of the front wheel. The damping system is composed by a damper (12) working in extension, between the chassis (9) and the fender (8) of the front wheel (6). The damping system of the rear wheel (20) comprises a damper (14) working by compression, between the chassis (9) and the balancer (16) which provides, together with the crank (18), the connection to the rear fender (19). That proposed system of steering, suspension and wheel fixation can be applied to any type of motorcycle or moped.

The direction of conventional motorcycles has a direct system in which the handlebar is directly connected to the support fork of the front axle, which makes wheel vibrations and shocks felt immediately by the driver. It also doesn't allow the fork angle of incidence that supports the wheel in the ground, to vary. The front suspension is also placed in the fork being necessary to find a commitment between an accurate damping direct system and an efficient damping system, which only is achieved when height in the front of motorcycle is increased regarding all inconvenients for the softness of the vehicle roller or expensive damping systems. It also must be referred that fenders of conventional motorcycle wheels are generally too far from wheels.

The present invention refers to the direction, suspension and fixation system of motorcycle wheels, with extension damping in front wheel and compression damping in rear wheel, aiming to absorb the resulting shocks and vibrations of the effect of the rolling damping considerably the shocks and vibrations transmitted to the motorcycle, as well as to the driver.

This system has a high rigid chassis which permits a higher rolling softness.

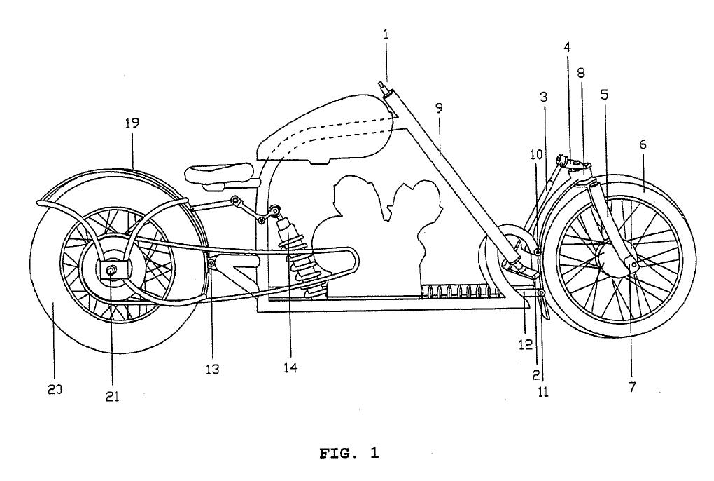

The FIG. 1 is a simplified and perspective schematic draw of the motorcycle according to the invention.

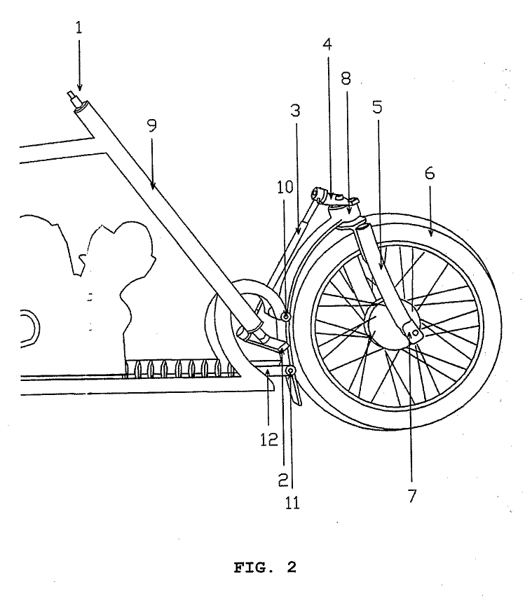

The FIG. 2 is a simplified and perspective schematic draw of the front of the motorcycle according to the invention, that illustrate the direction positioning of damping system that composes the suspension and fixation system of the front wheel.

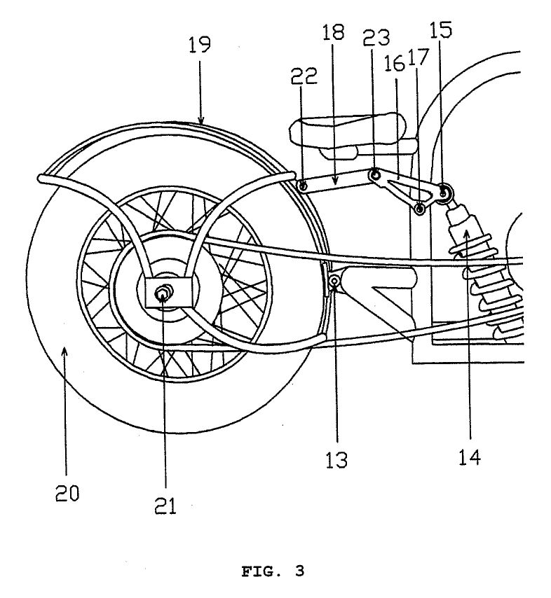

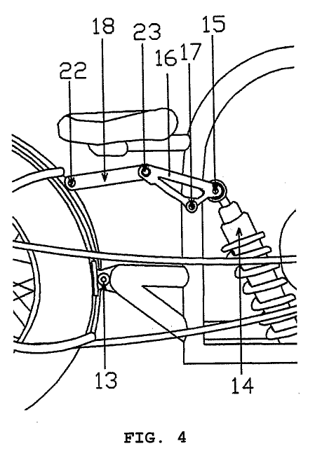

The FIG. 3 is a simplified and perspective schematic draw of a damping system detail which composes the suspension and the fixation system of the rear wheel.

### DESCRIPTION OF REQUESTED MATERIALIZATION

Referring to pictures it will be now described in a detailed way the characterization of the motorcycle that of invent and which is presented by a pictured example of the direction, suspension and fixation system of the wheels trough the fenders.

The direction is composed by a handlebar alongside of direction axle (1) connected to the support fork (5) of the front wheel (6). The cranks (3) have bearings at extremities, connected to the direction arms (2) and (4) which allows a fast alignment of the motorcycle direction.

The front suspension integrates a damping system composed by a damper (12) working in extension between the chassis (9) and the fender (8) of the front wheel support (6). This system aims to absorb the resulting shocks on the wheels by rolling effects, decreasing considerably the vibrations transmitted to the motorcycle, as well as to the driver.

The fixation system of the front wheel is achieved by an articulation (10) that connects the chassis (9) to the front fender (8) which backup the fork (5) which supports the wheel (6) by axle (7), this articulation (10) together with the bearing (11) of the front damper (12) allows to keep the fender (8) aligned which supports rigidly the articulation of the fork direction.

Besides this front axle damping system (7) the suspension of motorcycle also integrate the damping system at the back wheel (20) composed by a damper (14) working with compression, between the chassis (9) and the balancer (16) that assures together with the crank (18) the connection to the fender of rear wheel (19). The balancer (16) can turn over the bearing (17) connected to the chassis (9), working as a grip between the bearing (15) of connection to the damper and bearing to the crank (18). This balancer (16) has the function to allow the damper function in a position near the vertical firmly backup chassis in surroundings of motor, where the values of rigidity and resistance are higher.

The fixation system of the rear wheel is archived by the articulation (13) which links the chassis (9), in a elevated rigid and resistant zone, to the rear fender (19) that guarantees the connection to the axle (21) that support the wheel (20). This articulation (13) together with the bearing (22) of the crank (18) of the mechanism of rear damping allows to maintain aligned the fender (19) that supports rigidly the rear wheel. The crank (18) make use of the bearing (22) and (23) in their extremes in way of varies rapidly the height to the soil, in case it will be necessary, for example in a situation of passing through an asphaltic road to a track with accented several levels.

The present solution of direction, suspension and fixation of motorcycle wheels, allow a lower gravity centre of the vehicle, as well as the increase of softness of the roller thanks to the adopted damping system and to the rigidly of chassis.

That proposed kind of direction, suspension and fixation of wheels solution can be applied to any type of motorcycle or moped.

1-10. (canceled)

11. Stirring, suspension and fixation system for motorcycles wheels wherein it comprises:
an integrated stirring system at the front of the motorcycle having a mechanism composed by an handlebar. connected to the direction-axle (1), which rotates inside the chassis frame body (9), and operates an ann (2) which in turn is coupled to at least a crank (3) that has rotary joints at extremities and through a second arm (4) commands the motorcycle front forks (5) which are rotably connected over the. fender (8) and drive the front wheel (6);
a front suspension damping system composed by a damper (12) working in extension between the chassis (9) and the front wheel fender (8) through a first articulation (10) means which connect the chassis frame body (9) to the front fender (8), and together with a second articulation (11) means which connect the front damper (12) to the fender (8);
a rear compression damping system working by compression, between the chassis frame body (9) and the rear wheel fixation system through a first connection mechanism composed by a balancer (16) that has a central bearing (17) support connected to the chassis. (9) and balances the stresses imposed by the rear wheel damper (14) rotary joint (15) and a crank member (18) that has two rotary joints at extremities (22, 23) and creates the connection between the balancer (16) and the rear fender (19), a second connection is simply composed by of a rotary joint (13) that connects the chassis frame body (9) to the rear fender (19).

12. System according to claim 11, wherein the height of the motorcycle to the soil may vary rapidly by adapting the crank (18) position by means of the ‘two rotary joints at extremities (22, 23).

13. System according to claim 11, wherein a lower placement of the connections (10, 11,—13, 22) provides a lower gravity centre and a good roller capability.

14. System according to claim 11, wherein it can be applied to any kind of motorcycles or moped.
